(19) United States
(12) Patent Application Publication
(10) Pub. No.: US 2009/0015608 A1
(43) Pub. Date: Jan. 15, 2009

(54) INKJET IMAGE FORMING APPARATUS

(75) Inventors: Eun Bong HAN, Suwon-si (KR); Nam Kyun KIM, Seongnam-si (KR); Young Ung HA, Suwon-si (KR); Sung Joon PARK, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/061,835

(22) Filed: Apr. 3, 2008

(30) Foreign Application Priority Data
Jul. 13, 2007 (KR) 2007-0070522

(51) Int. Cl. B41J 2/145; B41J 29/38

(52) U.S. Cl. 347/9; 347/47

(57) ABSTRACT

Auxiliary nozzles to be used as substitutes for main nozzles formed near an ink feedhole in a print head. The main nozzles are used to perform printing when such nozzles are not defective. When a main nozzle has become defective and cannot normally jet ink, a corresponding spare nozzle is used to perform printing in place of the main nozzle.

### CROSS-REFERENCE TO RELATED APPLICATIONS

This application claims priority under 35 U.S.C. §119(a) from Korean Patent Application No. 2007-0070522, filed on Jul. 13, 2007 in the Korean Intellectual Property Office, the disclosure of which is incorporated herein in its entirety by reference.

### BACKGROUND OF THE INVENTION

1. Field of the Invention

The present general inventive concept relates to an inkjet image forming apparatus including a print head with an improved nozzle structure.

2. Description of the Related Art

An inkjet image forming apparatus generally jets ink to a recording medium through a plurality of nozzles formed on an inkjet head chip disposed in a print head to form an image on the recording medium.

As illustrated in FIG. 1, an inkjet head chip 10 disposed in a print head of a conventional inkjet image forming apparatus has an ink feedhole 20 formed along a longitudinal direction and includes a logic portion 40 and a pad portion 50 at either end of the ink feedhole 20. The inkjet head chip 50 also includes a nozzle portion 30 including a plurality of nozzles that are formed so as to communicate with the ink feedhole 20 in order to receive ink from the ink feedhole 20.

The nozzle portion 30 includes a row of odd nozzles and a row of even nozzles provided respectively at opposite sides of the ink feedhole 20. The row of odd nozzles and the row of even nozzles are arranged at regular intervals along the ink feedhole 20, where the row of odd nozzles are not aligned with the row of even nozzles by a regular interval.

As illustrated in FIG. 2, the nozzle portion 30 (FIG. 1) is formed by stacking a variety of structures. Specifically, a flow path layer 12 having nozzle holes is formed on a substrate 11 and an insulating layer 13, a heater 14, and an aluminum layer 15 are sequentially deposited between the substrate 11 and the flow path layer 12. A passivation layer 16 and an anti-cavitation layer 17 are deposited on the heater 14 immediately below each nozzle hole.

Ink provided through an ink feedhole 20 is filled in an ink chamber 21. The heater 14 is driven to heat the ink in the ink chamber 21 to form bubbles. An expansive force of the bubbles allows ink droplets to be discharged through the nozzle holes.

A state of each nozzle formed on the inkjet head chip affects an image formed on a recording medium. For example, quality of the image formed on the recording medium is lowered if a foreign substance is present in a nozzle hole or on a heating resistor in the print head so that no ink is discharged or that a smaller amount of ink than an appropriate amount is discharged.

In order to print a high quality image, the inkjet image forming apparatus must maintain the nozzle portion of the inkjet head in an appropriate state. To accomplish this, the inkjet image forming apparatus includes a maintenance device to maintain and maintain the nozzle portion of the inkjet print head in a normal state. The inkjet image forming apparatus generally performs maintenance operations such as spitting, wiping, and capping through the maintenance device.

If a nozzle is seriously clogged, restoring the state of the nozzle portion of the inkjet image forming apparatus is difficult even though the maintenance operations are performed to keep the nozzle portion in a normal state. The inkjet image forming apparatus may also not be equipped with the maintenance device or an equivalent function or may have dead nozzles that have been seriously damaged although being equipped with a maintenance device.

Thus, coping with a reduction in the image quality during printing due to an occurrence of dead nozzles in the print head is necessary.

### SUMMARY OF THE INVENTION

The present general inventive concept provides an inkjet image forming apparatus to use spare nozzles to cope with an occurrence of dead nozzles in a print head thereof.

Additional aspects and/or utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing an inkjet image forming apparatus including at least one print head, and a print head chip including a nozzle portion having at least one main nozzle and at least one auxiliary nozzle to jet ink provided through the print head, and a heater drive unit to drive at least one main heater and at least one auxiliary heater corresponding respectively to the at least one main nozzle and the at least one auxiliary nozzle.

The main and auxiliary nozzles can be aligned.

The main and auxiliary nozzles can not be aligned.

The main nozzle can be located at a shorter distance from an ink feedhole formed in the print head chip than the auxiliary nozzle.

The main nozzle and the auxiliary nozzle can share a flow path to provide ink through the ink feedhole.

The heater drive unit can selectively drive the main and auxiliary heaters that are aligned.

The heater drive unit can selectively drive the main and auxiliary heaters that are not aligned.

When the at least one main heater and the at least one auxiliary heater are divided into a plurality of groups of main and auxiliary heaters, the heater drive unit can include individual heater drive circuits corresponding respectively to the groups.

The heater drive circuit can include a common transistor commonly connected to a main heater and an auxiliary heater corresponding to the main heater, a first switching element connected in series between the main heater and a heater power source, and a second switching element connected in series between the auxiliary heater and the heater power source.

The heater drive circuit can further include a reverse current blocking diode.

Each of the first and second switching elements can use a PMOS FET and the common transistor can use an NMOS FET.

The first switching element can be commonly connected to the main heaters of a corresponding one of the groups and the second switching element can be commonly connected to the auxiliary heaters of a corresponding one of the groups.

The first and second switching elements can be arranged in parallel along a longitudinal direction of the print head chip.

The foregoing and/or other aspects and utilities of the present general inventive concept may also be achieved by providing an inkjet image forming apparatus having a print head chip disposed in a print head, the apparatus including an ink feedhole formed in the print head chip, a first nozzle to perform printing with ink received from the ink feedhole, a second nozzle to perform printing in place of the first nozzle, a first heater corresponding to the first nozzle, a second heater corresponding to the second nozzle, and a heater drive unit to drive the first and second heaters.

The first nozzle can be located at a shorter distance from the ink feedhole than the second nozzle.

The first and second nozzles can be aligned.

The first and second nozzles can not be aligned.

The heater drive unit can include an NMOS FET commonly connected to the first and second heaters, a first PMOS FET connected in series between the first heater and a heater power source, and a second PMOS FET connected in series between the second heater and the heater power source.

The heater drive unit can further include a first reverse current blocking diode connected in series between the first heater and the first PMOS FET and a second reverse current blocking diode connected in series between the second heater and the second PMOS FET.

A first interval during which the NMOS FET is turned on to drive the first or second heater is longer than a second interval during which the first or second PMOS FET is turned on.

The foregoing and/or other aspects and utilities of the general inventive concept may also be achieved by providing an inkjet image forming apparatus including at least one main nozzle to eject ink, and having a normal state and a defective state, at least one auxiliary nozzle corresponding to the respective main nozzle to eject ink, and having an active state and an inactive state, and a controller to place the corresponding auxiliary nozzle in the active state when the respective main nozzle is in the defective state, wherein the corresponding auxiliary nozzle placed in the active state allows the ink to be selectively ejected from the corresponding auxiliary nozzle instead of the respective main nozzle.

The at least one main nozzle and the at least one auxiliary nozzle can be embodied on a print head chip.

The at least one main nozzle can be a plurality of main nozzles arranged in a first line, and the at least one auxiliary nozzle can be a plurality of auxiliary nozzles corresponding to the main nozzles, and arranged in a second line, wherein the first line and the second line are staggered.

The apparatus can further include main heaters corresponding to each of the plurality of main nozzles, and auxiliary heaters corresponding to each of the plurality of auxiliary nozzles.

The foregoing and/or other aspects and utilities of the general inventive concept may also be achieved by providing an inkjet printing method including determining which of a plurality of main nozzles are in a defective state, placing auxiliary nozzles corresponding to the main nozzles determined to be in the defective state in an active state, and selectively ejecting ink corresponding to image data through the respective auxiliary nozzles placed in the active state and the respective plurality of main nozzles not determined to be in the defective state.

The foregoing and/or other aspects and utilities of the general inventive concept may also be achieved by providing a computer-readable recording medium having embodied thereon a computer program to execute a method, wherein the method includes determining which of a plurality of main nozzles are in a defective state, placing auxiliary nozzles corresponding to the main nozzles determined to be in the defective state in an active state, and selectively ejecting ink corresponding to image data through the respective auxiliary nozzles placed in the active state and the respective plurality of main nozzles not determined to be in the defective state.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 schematically illustrates a flow path structure of an inkjet head chip applied to a conventional inkjet image forming apparatus;

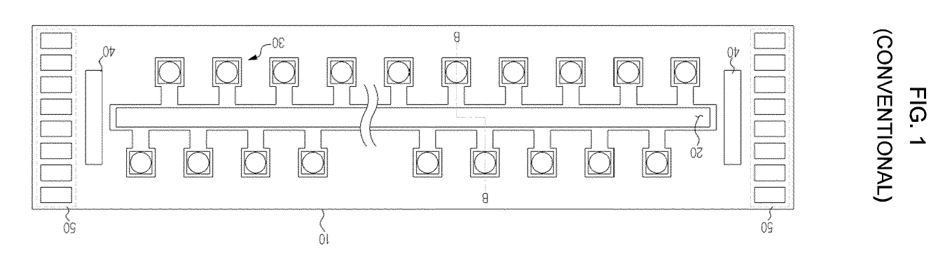

FIG. 2 is a cross-sectional view taken along a line B-B of FIG. 1;

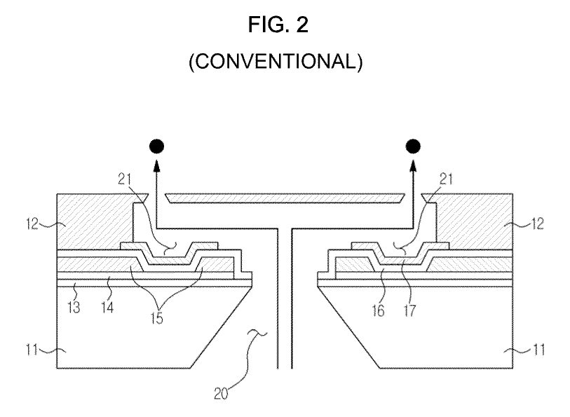

FIG. 3 schematically illustrates a flow path structure of an inkjet head chip applied to an inkjet image forming apparatus according to an embodiment of the present general inventive concept;

FIG. 4 illustrates an example where main and auxiliary nozzles applied to the flow path structure of the inkjet head chip of FIG. 3 are aligned with each other;

FIG. 5 schematically illustrates a flow path structure of an inkjet head chip applied to an inkjet image forming apparatus according to another embodiment of the present general inventive concept;

FIG. 6 illustrates an example where main and auxiliary nozzles applied to the flow path structure of the inkjet head chip of FIG. 5 are not aligned with each other;

FIG. 7 illustrates an overall arrangement of an inkjet head chip applied to an inkjet image forming apparatus according to an embodiment of the present general inventive concept, where a heater drive unit is divided into a plurality of groups;

FIG. 8 illustrates a detailed configuration of the heater drive unit illustrated in FIG. 7;

FIG. 9 illustrates a heater drive circuit corresponding to the first group when the heater drive unit is divided into the plurality of groups in the inkjet head chip applied to the inkjet image forming apparatus according to the embodiment of the present general inventive concept;

FIG. 10 is a timing diagram illustrating the operation timing of each component to drive heaters in the heater drive circuit of the first group of FIG. 9; and

FIG. 11 is a flowchart illustrating an inkjet printing method according to an embodiment of the present general inventive concept.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to the like elements throughout. The embodiments are described below in order to explain the present general inventive concept by referring to the figures.

A description will now be given of an inkjet image forming apparatus according to embodiments of the present general inventive concept.

Generally, any nozzle may become unable to normally perform ink jetting or may become dead in a print head chip disposed in a print head applied to an inkjet image forming apparatus.

The embodiments of the present general inventive concept employ a structure in which a main nozzle and an auxiliary nozzle corresponding to the main nozzle are provided in a print head chip and the main nozzle is used to jet ink during printing when the main nozzle is not defective and the auxiliary nozzle is used to jet ink when the main nozzle is defective.

A general method to detect dead nozzles in a print head chip is that the user or service engineer performs a test print to identify dead nozzles and then inputs information of the nozzles to the apparatus or uses an optical device such as a scanner to automatically recognize a pattern on the test printed recording medium to identify dead nozzles.

Although the structure described above is applied to every nozzle in the print head chip in the embodiments, the present general inventive concept is not limited to the specific structure. For example, a modification may employ a structure in which each odd nozzle includes a plurality of (main and auxiliary) nozzles and each even nozzle includes a single nozzle. A modification may employ a contrary structure in which each even nozzle includes a plurality of (main and auxiliary) nozzles and each odd nozzle includes a single nozzle. Another modification may employ a structure in which some of the even nozzles and some of the odd nozzles each include a plurality of (main and auxiliary) nozzles and remaining nozzles each include a single nozzle.

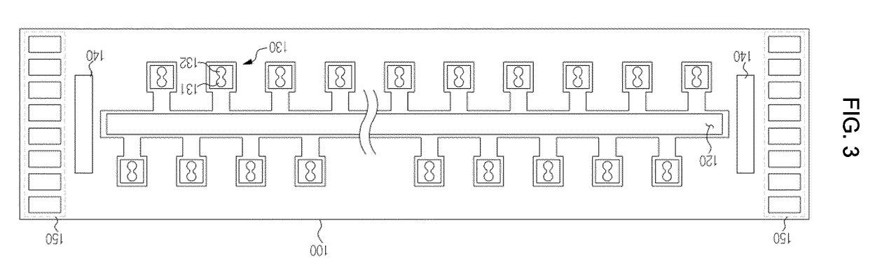

As illustrated in FIG. 3, an inkjet head chip 100 that is disposed in a print head of an inkjet image forming apparatus according to an embodiment of the present general inventive concept has an ink feedhole 120 to supply ink received from an ink supply unit (not illustrated) to each nozzle. The inkjet head chip 100 includes a logic portion 140 and a pad portion 150 at either end of the ink feedhole 120. The inkjet head chip 100 also includes a nozzle portion 130 including a plurality of nozzles that are formed so as to communicate with the ink feedhole 120 in order to receive ink from the ink feedhole 120.

The structure of the nozzle portion 130 according to this embodiment is similar to that of conventional nozzle portions in that a row of odd nozzles and a row of even nozzles are arranged along the ink feedhole 120 in a staggered fashion at both sides of the ink feedhole 120 such that the odd nozzles are not aligned with the even nozzles by a specific interval.

One feature of the nozzle portion 130 according to the present general inventive concept is that the nozzle portion 130 includes pairs of main and auxiliary nozzles 131 and 132. The main nozzles 131 are formed near the ink feedhole 120 and the auxiliary nozzles 132 are formed relatively distant from the ink feedhole 120. Each of the auxiliary nozzles 132 is located in a line with a corresponding main nozzle 131. When the main nozzles 131 are not defective, the main nozzles 131 are used to perform printing. However, when a main nozzle is defective and thus cannot normally jet ink, a corresponding auxiliary nozzle is used as a substitute for the main nozzle to perform printing.

According to this embodiment, each of the main and auxiliary nozzles 131 and 132 individually include a heat source that is provided under an ink chamber of the nozzle to heat ink filled in the ink chamber. That is, main heaters corresponding to the main nozzles and auxiliary heaters corresponding to the auxiliary nozzles are formed in the head chip such that each heater is associated with a corresponding nozzle.

In this manner, the main heaters are selectively controlled (or driven) to allow the main nozzles to jet ink and the auxiliary heaters are selectively controlled to allow the auxiliary nozzles to jet ink. That is, the main heaters are controlled to allow the main nozzles to jet ink when they are normal. However, when a main nozzle is defective, an auxiliary heater of a corresponding auxiliary nozzle is controlled to allow the auxiliary nozzle to jet ink.

Reference will now be made in more detail to a flow path structure of an inkjet head chip improved according to this embodiment.

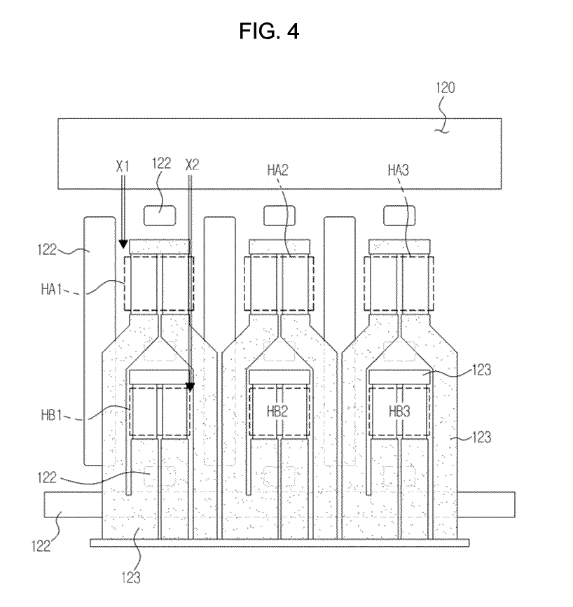

FIG. 4 illustrates a separated portion of a flow path layer formed in the head chip of the print head. From this figure, locations of main and auxiliary heaters which are heat sources corresponding to main and auxiliary nozzles are illustrated.

In FIG. 4, a main heater HA1 is disposed in association with a nozzle hole of a main nozzle 131 (FIG. 3) that is located near an ink feedhole 120 and an auxiliary heater HB1 is disposed in association with a nozzle hole of an auxiliary nozzle 132. A heater wiring 123 is electrically connected to the main heater HA1 and the auxiliary heater HB1. The heater wiring 123 allows a pulse current provided by a controller of the apparatus to flow through each heater so as to heat ink.

An ink chamber structure 122 is formed around the main heater HA1 and the auxiliary heater HB1 so that a portion of the ink provided through the ink feedhole 120 is first filled in an ink chamber adjacent to the main heater HA1 as illustrated by an arrow X1 and is then filled in an ink chamber adjacent to the auxiliary heater HB1 that is more distant than the main heater HA1 as illustrated by an arrow X2.

In this manner, ink is filled in ink chambers adjacent to other main and auxiliary heaters HA2, HA3, HB2, and HB3.

Although FIG. 4 illustrates an arrangement of main and auxiliary heaters corresponding to main and auxiliary nozzles of the printer head, main heaters are provided respectively for main nozzles and auxiliary heaters are provided respectively for auxiliary nozzles.

In the above embodiment, each pair of main and auxiliary nozzles are arranged in a line and the auxiliary nozzle is used as a substitute for the main nozzle when the main nozzle is defective.

In the following embodiment, main and auxiliary nozzles are arranged such that they are not aligned. This provides not only the function to use the auxiliary nozzle as a substitute for the main nozzle when the main nozzle is defective but also an additional function to control the main and auxiliary nozzles, which are not aligned, to jet ink to perform printing when any of the main and auxiliary nozzles is not defective. This additional function can increase the print resolution, compared to when only one of the main and auxiliary nozzles is used.

Reference will now be made in more detail to a flow path structure of an inkjet head chip improved according to this embodiment. In the following description, elements similar to the elements of the previous embodiment will be denoted by the same reference numerals.

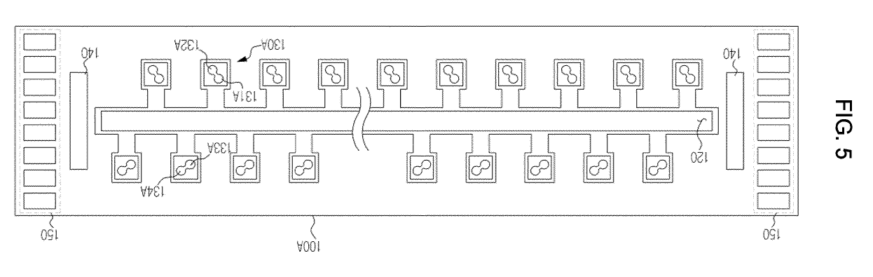

As illustrated in FIG. 5, an inkjet head chip 100A that is disposed in a print head of an inkjet image forming apparatus according to an embodiment of the present general inventive concept has an ink feedhole 120 to supply ink received from an ink supply unit (not illustrated) to each nozzle and includes a logic portion 140 and a pad portion 150 at either end of the ink feedhole 120. The inkjet head chip 100 also includes a nozzle portion 130A including a plurality of nozzles that are formed so as to communicate with the ink feedhole 120 in order to receive ink from the ink feedhole 120.

The structure of the nozzle portion 130A according to this embodiment is similar to that of conventional nozzle portions in that a row of odd nozzles and a row of even nozzles are arranged along the ink feedhole 120 in a staggered fashion at both sides of the ink feedhole 120 such that the odd nozzles are not aligned with the even nozzles by a specific interval. The following are features of this embodiment. Each odd nozzle of the nozzle portion 130A includes first main and auxiliary nozzles 131A and 132A arranged such that they are not aligned with each other and an even nozzle next to the odd nozzle includes second main and auxiliary nozzles 133A and 134A arranged at the opposite side of the ink feedhole 120 such that the first main and auxiliary nozzles 131A and 132A are not aligned with each other. The first auxiliary nozzle 132A is located between the first main nozzle 131A and the second main nozzle 133A. In this manner, main and auxiliary nozzles at one side of the ink feedhole and main and auxiliary nozzles at the opposite side are arranged sequentially at specific intervals along the longitudinal direction of the ink feedhole.

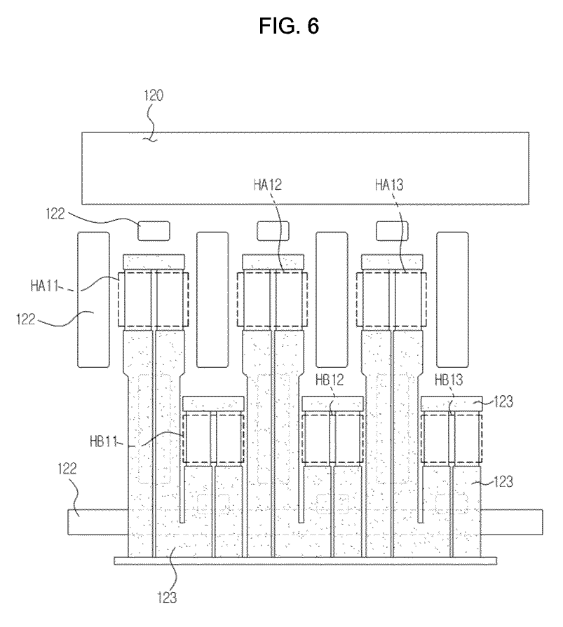

FIG. 6 illustrates a separated portion of a flow path layer formed in the head chip of the print head. From this figure, main and auxiliary heaters which are heat sources corresponding to main and auxiliary nozzles are illustrated.

Referring to FIGS. 5 and 6, a main heater HA11 is disposed in association with a nozzle hole of a main nozzle 131A that is located near an ink feedhole 120 and an auxiliary heater HB11 is disposed in association with a nozzle hole of an auxiliary nozzle 132A. The main and auxiliary heaters HA11 and HB11 are arranged at positions corresponding to the main and auxiliary nozzles 131A and 132A such that the main and auxiliary heaters HA11 and HB11 are not aligned with each other.

A heater wiring 123 is electrically connected to the main and auxiliary heaters HA11 and HB11 that are not aligned. The heaterwiring 123 allows a pulse current provided by a controller of the apparatus to flow through each heater so as to heat ink.

An ink chamber structure 122 is formed around the main and auxiliary heaters HA11 and HB11 that are not aligned so that a portion of the ink provided through the ink feedhole 120 is first filled in an ink chamber corresponding to the main heater HA11 and is then filled in an ink chamber corresponding to the auxiliary heater HB11, which is more distant than the main heater HA11.

In this manner, ink is filled in ink chambers adjacent to other main and auxiliary heaters HA12 and HA13 and HB12 and HB13.

Regardless of whether or not main and auxiliary nozzles are aligned, the main and auxiliary nozzles have a common flow path to receive ink from the ink feedhole and perform an actual operation to jet ink solely through control of main and auxiliary heaters provided respectively for the main and auxiliary nozzles.

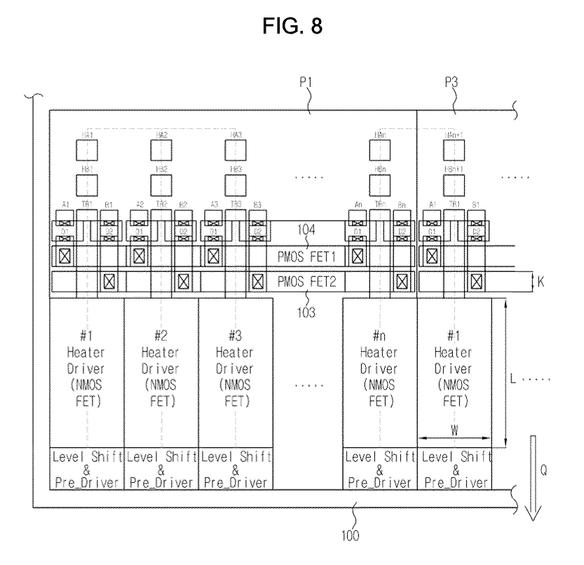

Reference will now be made to a heater control operation that can be applied to the two embodiments described above. Although FIG. 8 illustrates an embodiment where main and auxiliary heaters are aligned for the sake of convenience, the present general inventive concept can also be applied to another embodiment, not illustrated, where main and auxiliary heaters are not aligned.

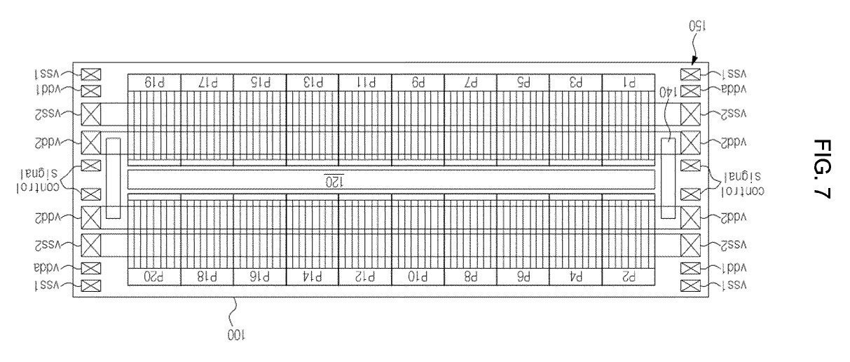

As illustrated in FIG. 7, an inkjet head chip 100 applied to an inkjet image forming apparatus according to an embodiment of the present general inventive concept includes a logic portion 140 and a pad portion 150 located at either end of an ink feedhole 120.

Each pad portion 150 includes a plurality of terminals to provide power vss1, vdd1, vss2, vdd2, and vdda required to drive heaters and to provide control signals that a controller of the apparatus provides to the printer head.

As illustrated in FIG. 7, a heater drive unit, to drive main and auxiliary heaters of the printer head to control ink jetting operations thereof, is divided into 1st to 20th drive groups P1, P2, P3, . . . , P19, and P20 for efficient control.

Reference will now be made to the first heater drive group P1 of the inkjet head chip 100 as a representative of the heater drive unit with reference to FIG. 8.

In order to drive main and auxiliary heaters HA1 and HB1, diodes D1 and D2, a first switching element (PMOS FET1) 104, a second switching element (PMOS FET2) 103, a first heater driver (#1 Heater Driver NMOS FET), and a heater control signal level controller (Level Shift & Driver) are arranged sequentially along the transverse direction of the head chip. The components are arranged in the same manner for each other pair of main and auxiliary heaters. Here, we omit a detailed description of the configurations of the first heater driver (#1 Heater Driver NMOS FET) and the heater control signal level controller (Level Shift & Driver) since the configurations are also applied to the conventional apparatus and are also known in the art.

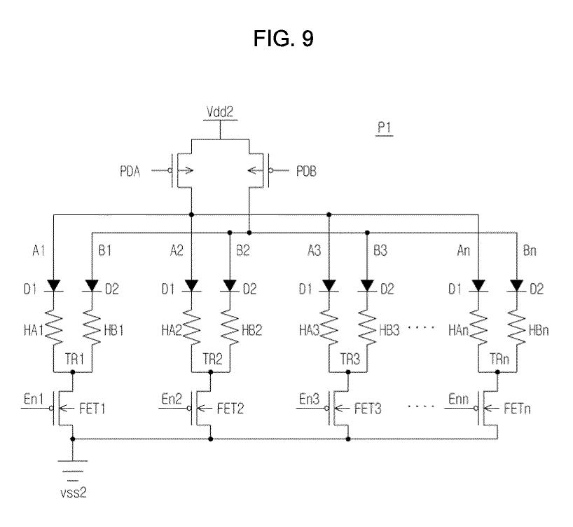

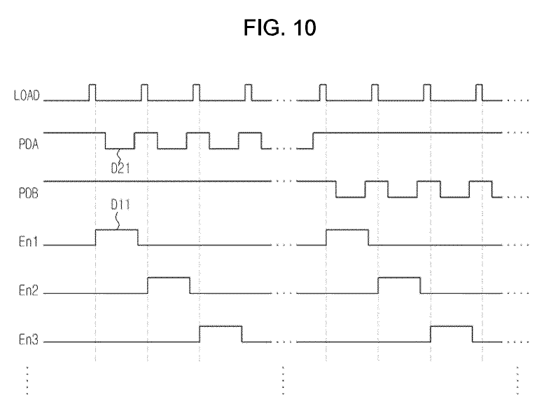

The first switching element 104 and the second switching element 103 are commonly used in each group. The first switching element 104 functions to drive the main heaters and the second switching element 103 functions to drive the auxiliary heaters. The first and second switching elements 104 and 103 will now be described in detail with reference to FIGS. 9 and 10.

As illustrated in FIG. 9, a first NMOS FET (FET1) of the first heater driver is commonly connected to ends of the main and auxiliary heaters HA1 and HB1 through a connection point TR1.

A PMOS FET1 (PDA) of the first switching element 104 is connected in series to an other end of the main heater HA1 and a PMOS FET2 (PDB) of the second switching element 103 is connected in series to an other end of the auxiliary heater HB1.

When the first NMOS FET (FET1) is on, the main heater HA1 or the auxiliary heater HB1 can be selectively driven by turning on one of the PMOS FET1 (PDA) of the first switching element 104 or the PMOS FET2 (PDB) of the second switching element 103 and heater power Vdd2 is provided to the driven heater to allow a pulse current to flow through the heater.

As illustrated in FIG. 10, when the logic portion 140 applies a turn-on signal En1 to an NMOS FET (for example, the first NMOS FET (FET1)) for a corresponding nozzle according to a LOAD signal provided from the pad portion 150, the first NMOS FET (FET1) is turned on during a first interval D11 according to the signal En1.

After the first NMOS FET (FET1) is turned on according to the LOAD signal applied to it, the PMOS FET1 (PDA) of the first switching element 104 is turned on during a second interval D21. The second interval D21 is set to be shorter than the first interval D11 in order to achieve stable driving of the PMOS FET1 (PDA). At this time, the PMOS FET2 (PDB) of the second switching element 103 is off. Accordingly, a pulse current flows through the main heater HA1 so that the main heater HA1 starts heating ink in an ink chamber to allow the corresponding main nozzle to jet the heated ink.

Alternatively, if the PMOS FET2 (PDB) of the second switching element 103 is turned on when the first NMOS FET (FET1) remains on after being turned on according to the LOAD signal applied thereto, a pulse current flows through the auxiliary heater HB1 so that the auxiliary heater HB1 starts heating ink in an ink chamber to allow the corresponding auxiliary nozzle to jet the heated ink.

A first diode D1 is connected in series between the PMOS FET1 (PDA) of the first switching element 104 and each of the main heaters HA1, HA2, HA3, . . . , and HAn and a second diode D2 is connected in series between the PMOS FET2 (PDB) of the second switching element 103 and each of the auxiliary heaters HB1, HB2, HB3, . . . , and HBn.

Each of the first and second diodes D1 and D2 is a reverse current blocking diode. When one of the PMOS FET1 (PDA) of the first switching element 104 or the PMOS FET2 (PDB) of the second switching element 103 is turned on to drive a corresponding one of a main heater or an auxiliary heater, the first and second diodes D1 and D2 prevent a reverse current from flowing through not only the driven heater but also other heaters which should not be driven. It is possible to prevent simultaneous driving of main and auxiliary heaters is prevented since the first and second diodes D1 and D2 block reverse currents.

Referring to FIG. 8, according to this embodiment, the PMOS FET1 (PDA) of the first switching element 104 is commonly connected to main heaters of each individual group and the PMOS FET2 (PDB) of the second switching element 103 is commonly connected to auxiliary heaters of each individual group. Accordingly, a required design area is achieved even if the head chip is not or slightly extended in the transverse direction (Q) when the PMOS FETs of the first and second switching elements 140 and 130 are designed. For example, the design area of the PMOS FET2 is determined based on a width K thereof smaller than a length L of the NMOS FET of the head chip, a number of NMOS FETs in the group, and the interval W between nozzles. Thus, a larger design area is secured as the number of shared NMOS FETs increases, thereby preventing an increase in a size of the head chip in the transverse direction.

The PMOS FETs, which constitute the first and second switching elements, generally satisfy a requirement that the design area of the PMOS FETs be about twice that of the NMOS FETs. The inkjet image forming apparatus of the present general inventive concept can prevent an increase in the head chip size since the head chip has a structure, satisfying this requirement, in which the PMOS FETs are each formed along the direction of the arrangement of the nozzles which are arranged along the longitudinal direction of the ink feedhole.

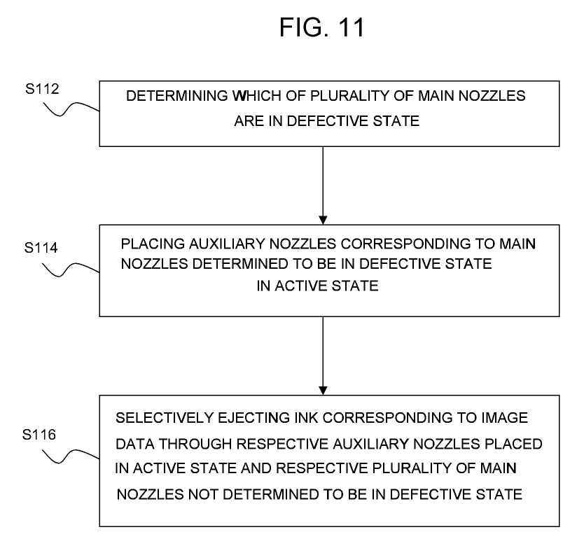

FIG. 11 is a flowchart illustrating an inkjet printing method according to an embodiment of the present general inventive concept. Referring to FIG. 11, in operation S112, which of a plurality of main nozzles are in a defective state is determined. In operation S114, auxiliary nozzles corresponding to the main nozzles determined to be in the defective state are placed in an active state. In operation S116, the respective auxiliary nozzles placed in the active state and the respective plurality of main nozzles not determined to be in the defective state are used to selectively eject ink corresponding to image data.

The present general inventive concept can also be embodied as computer-readable codes on a computer-readable medium. The computer-readable medium can include a computer-readable recording medium and a computer-readable transmission medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As is apparent from the above description, various embodiments of the present general inventive concept provide an inkjet image forming apparatus with a variety of utilities. For example, when a main nozzle becomes defective in a print head, an auxiliary nozzle is used as a substitute for the main nozzle to perform a normal printing operation.

The auxiliary nozzle is arranged such that the auxiliary nozzle is not aligned with the main nozzle so that both the main and auxiliary nozzles can be used for normal printing to increase resolution of an image to be printed.

Various embodiments of the present general inventive concept also allow each switching element to be commonly used in a corresponding heater drive circuit, thereby minimizing a size of the print head chip while achieving a required design area of the switching element.

Although various embodiments of the present general inventive concept have been illustrated and described, it would be appreciated by those skilled in the art that changes may be made in these embodiments without departing from the principles and spirit of the general inventive concept, the scope of which is defined in the appended claims and their equivalents.

What is claimed is:

1. An inkjet image forming apparatus, comprising:
at least one print head; and
a print head chip including a nozzle portion having at least one main nozzle and at least one auxiliary nozzle to jet ink provided through the print head, and a heater drive unit to drive at least one main heater and at least one auxiliary heater corresponding respectively to the at least one main nozzle and the at least one auxiliary nozzle.

2. The inkjet image forming apparatus according to claim 1, wherein the main and auxiliary nozzles are aligned.

3. The inkjet image forming apparatus according to claim 1, wherein the main and auxiliary nozzles are not aligned.

4. The inkjet image forming apparatus according to claim 1, wherein the main nozzle is located at a shorter distance from an ink feedhole formed in the print head chip than the auxiliary nozzle.

5. The inkjet image forming apparatus according to claim 4, wherein the main nozzle and the auxiliary nozzle share a flow path to provide ink through the ink feedhole.

6. The inkjet image forming apparatus according to claim 2, wherein the heater drive unit selectively drives the main and auxiliary heaters that are aligned.

7. The inkjet image forming apparatus according to claim 3, wherein the heater drive unit selectively drives the main and auxiliary heaters that are not aligned.

8. The inkjet image forming apparatus according to claim 1, wherein, when the at least one main heater and the at least one auxiliary heater are divided into a plurality of groups of main and auxiliary heaters, the heater drive unit includes individual heater drive circuits corresponding respectively to the groups.

9. The inkjet image forming apparatus according to claim 8, wherein the heater drive circuit comprises:
a common transistor commonly connected to a main heater and an auxiliary heater corresponding to the main heater;
a first switching element connected in series between the main heater and a heater power source; and
a second switching element connected in series between the auxiliary heater and the heater power source.

10. The inkjet image forming apparatus according to claim 9, wherein the heater drive circuit further comprises:
a reverse current blocking diode.

11. The inkjet image forming apparatus according to claim 8, wherein each of the first and second switching elements uses a PMOS FET and the common transistor uses an NMOS FET.

12. The inkjet image forming apparatus according to claim 8, wherein the first switching element is commonly connected to the main heaters of a corresponding one of the groups and the second switching element is commonly connected to the auxiliary heaters of a corresponding one of the groups.

13. The inkjet image forming apparatus according to claim 8, wherein the first and second switching elements are arranged in parallel along a longitudinal direction of the print head chip.

14. An inkjet image forming apparatus having a print head chip disposed in a print head, the apparatus comprising:
an ink feedhole formed in the print head chip;
a first nozzle to perform printing with ink received from the ink feedhole;
a second nozzle to perform printing in place of the first nozzle;
a first heater corresponding to the first nozzle;
a second heater corresponding to the second nozzle; and
a heater drive unit to drive the first and second heaters.

15. The inkjet image forming apparatus according to claim 14, wherein the first nozzle is located at a shorter distance from the ink feedhole than the second nozzle.

16. The inkjet image forming apparatus according to claim 14, wherein the first and second nozzles are aligned.

17. The inkjet image forming apparatus according to claim 14, wherein the first and second nozzles are not aligned.

18. The inkjet image forming apparatus according to claim 14, wherein the heater drive unit comprises:
an NMOS FET commonly connected to the first and second heaters;
a first PMOS FET connected in series between the first heater and a heater power source; and
a second PMOS FET connected in series between the second heater and the heater power source.

19. The inkjet image forming apparatus according to claim 18, wherein the heater drive unit further comprises:
a first reverse current blocking diode connected in series between the first heater and the first PMOS FET; and
a second reverse current blocking diode connected in series between the second heater and the second PMOS FET.

20. The inkjet image forming apparatus according to claim 18, wherein a first interval during which the NMOS FET is turned on to drive the first or second heater is longer than a second interval during which the first or second PMOS FET is turned on.

21. An inkjet image forming apparatus, comprising:
at least one main nozzle to eject ink, and having a normal state and a defective state;
at least one auxiliary nozzle corresponding to the respective main nozzle to eject ink, and having an active state and an inactive state; and
a controller to place the corresponding auxiliary nozzle in the active state when the respective main nozzle is in the defective state,
wherein the corresponding auxiliary nozzle placed in the active state allows the ink to be selectively ejected from the corresponding auxiliary nozzle instead of the respective main nozzle.

22. The apparatus of claim 21, wherein the at least one main nozzle and the at least one auxiliary nozzle are embodied on a print head chip.

23. The apparatus of claim 21, wherein:
the at least one main nozzle is a plurality of main nozzles arranged in a first line; and
the at least one auxiliary nozzle is a plurality of auxiliary nozzles corresponding to the main nozzles, and arranged in a second line,
wherein the first line and the second line are staggered.

24. The apparatus of claim 23, further comprising:
main heaters corresponding to each of the plurality of main nozzles; and
auxiliary heaters corresponding to each of the plurality of auxiliary nozzles.

25. An inkjet printing method, comprising:
determining which of a plurality of main nozzles are in a defective state;
placing auxiliary nozzles corresponding to the main nozzles determined to be in the defective state in an active state; and
selectively ejecting ink corresponding to image data through the respective auxiliary nozzles placed in the active state and the respective plurality of main nozzles not determined to be in the defective state.
